(19) United States
(12) Patent Application Publication
(10) Pub. No.: US 2026/0148331 A1
(43) Pub. Date: May 28, 2026

(54) ADAPTIVE BANK HASH FUNCTIONS

(71) Applicant: QUALCOMM Incorporated, San Diego, CA (US)

(72) Inventors: Suryanarayana Murthy DURBHAKULA, Hyderabad (IN); Adarsh GOLIKERI, Bengaluru (IN)

(21) Appl. No.: 18/963,375

(22) Filed: Nov. 27, 2024

(51) Int. Cl. G06T 1/60; G06T 1/20

(52) U.S. Cl. CPC G06T 1/60; G06T 1/20

(57) ABSTRACT

This disclosure provides systems, devices, apparatus, and methods, including computer programs encoded on storage media, for dynamic bank hash functions. A graphics processor may be configured to determine a first hash function of a set of hash functions associated with a memory bank of a memory for a first processing interval of a workload. The graphics processor may be configured to execute, as a first foreground process and during the first processing interval of the workload, the first hash function of the set of hash functions. The graphics processor may also be configured to execute, as a set of background processes and during the first processing interval of the workload, a second hash function of the set of hash functions for the memory bank, and subsequently execute the hash function with the fewest memory access conflicts in a later processing interval of the workload.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for graphics processing may utilize a bank hash function, in association with concurrent accesses to banks of a memory, for determinations of bank conflicts of workloads, but may not address issues that arise for single or multiple workloads utilizing a single bank hash function. There is a need for improved techniques for implementing bank hash functions such that multiple hash function options are available for selection thereof to improve memory efficiency.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: determine a first hash function of a set of hash functions associated with a memory bank of a memory for a first processing interval of a workload; and execute, as a first foreground process and during the first processing interval of the workload, the first hash function of the set of hash functions.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 illustrates an example of hash function utilization to determine memory access conflicts.

FIG. 5 illustrates an example of adaptive bank hash functions for workloads in accordance with one or more techniques of this disclosure.

FIG. 6 illustrates an example of adaptive bank hash functions for workloads in accordance with one or more techniques of this disclosure.

FIG. 7 illustrates an example of adaptive bank hash functions for workloads in accordance with one or more techniques of this disclosure.

FIG. 8 is a call flow diagram illustrating example communications between a CPU and a GPU in accordance with one or more techniques of this disclosure.

FIG. 9 is a flowchart of an example method of graphics processing in accordance with one or more techniques of this disclosure.

FIG. 10 is a flowchart of an example method of graphics processing in accordance with one or more techniques of this disclosure

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “workload” may refer to a program or application that is processed by a processor, e.g., a GPU, such as a gaming application, productivity applications, graphics applications, workbench analysis applications, etc. As used herein, the terms “hash function” and “bank hash function” may refer to algorithms by which data for a memory bank may be converted to a fixed length value and by which memory bank access conflicts may be determined. As used herein, the terms “bank” and “memory bank” may refer to a segment of a memory associated with specific data and by which concurrent accesses may be enabled. As used herein, the terms “processing interval” and “observation interval” may be used interchangeably and may refer to a number of memory bank accesses, a period of time, etc., during processing of a workload, for which memory bank access conflicts may be determined for adaptive bank hash functions. As used herein, the term “foreground process” may refer to a process executed in conjunction with processing of a workload to perform operations utilized during the processing of a workload, while the term “background process” may refer to a process executed in association with processing of a workload without affecting the processing of a workload.

GPUs may utilize a relatively small, low latency memory to access frequently used data. As examples, a local memory, a cache, a scratchpad memory, and/or the like may be used by a GPU for such access. To enable concurrent access by different fibers during workload processing, the memory may be arranged as banks, yet bank access conflicts may negatively impact local memory performance. A bank hash function may be utilized to determine the number of bank access conflicts for different workloads. However, no one memory bank hash function may perform well for all workloads. Further, even for a single workload during its entire duration, no one bank hash function may be ideal.

Aspects herein for adaptive bank hash functions enable multiple bank hash functions to be run and observed in the background, and provide for adaptive determinations of the best performing bank hash function. In some aspects, the best performing bank hash function may be selected and kept constant for the entire duration of a workload. In some aspects, an initial bank hash function may be picked, while other bank hash functions may be run in the background to calculate respective numbers of bank conflicts for the different bank hash functions. At certain intervals, the bank hash functions may be compared, and the best bank hash function (e.g., the bank hash function with the lowest number of conflicts, the most suitable bank hash function, the bank hash function that is executed the fastest, etc.) may be adaptively selected and set as the current bank hash function. In some aspects, to provide additional stability, prevention of changes for the bank hash functions, e.g., for K number of intervals after a new bank hash function is selected, is enabled. That is, aspects provide for a number of well performing bank hash functions to be picked, e.g., a number N (such as 2, 3, 4, etc.), and the bank hash function to be utilized may be adaptively change to one of the three options at run time. The other bank hash functions may be kept running in the background, and at the end of an observation interval, the best bank hash function may be re-evaluated for the next observation interval. Aspects may be implemented as part of a GPU microarchitecture for memory performance improvements, and may be extensible to different graphics processing configurations/use cases, as well as different types of workloads. Accordingly, aspects provide for dynamic bank hash function implementations in which multiple hash function options are available for selection thereof to improve memory efficiency and overall GPU performance.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

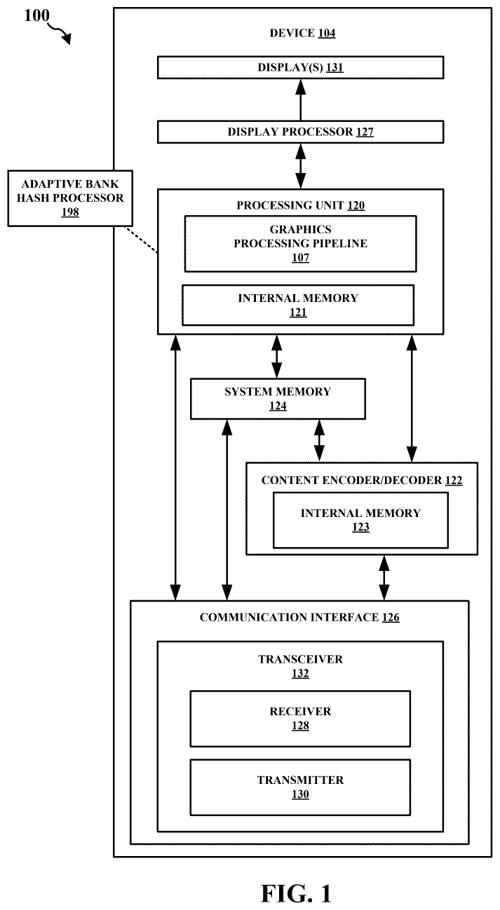

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an adaptive bank hash processor 198 configured to determine a first hash function of a set of hash functions associated with a memory bank of a memory for a first processing interval of a workload, and to execute, as a first foreground process and during the first processing interval of the workload, the first hash function of the set of hash functions. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

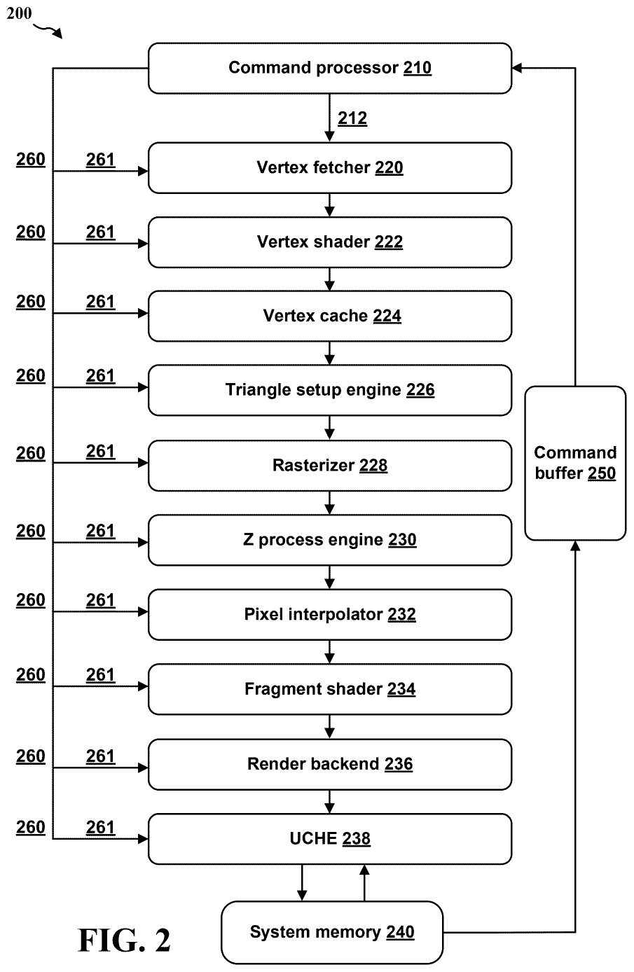

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

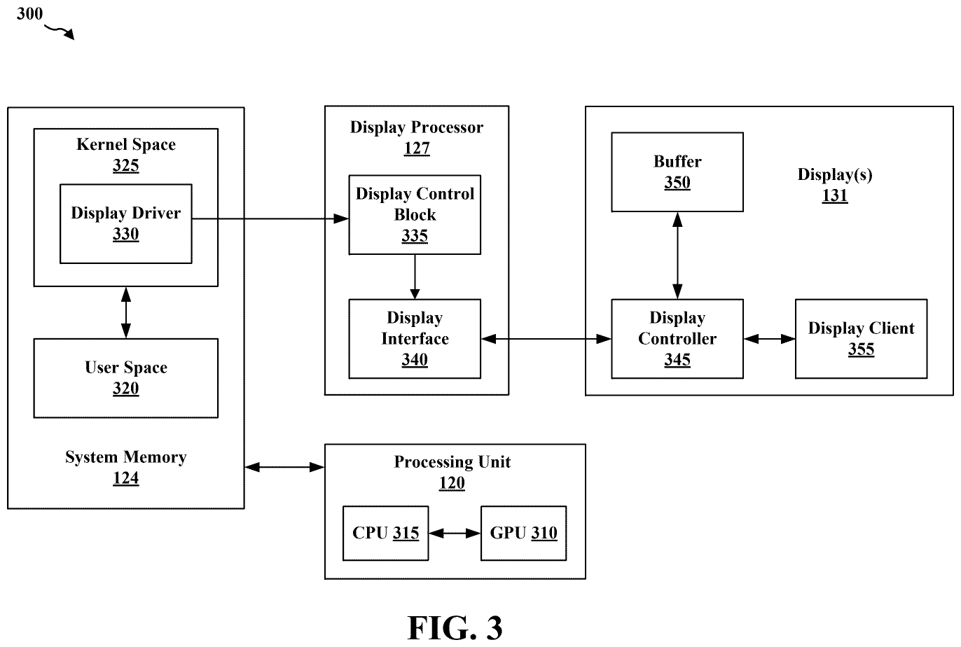

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

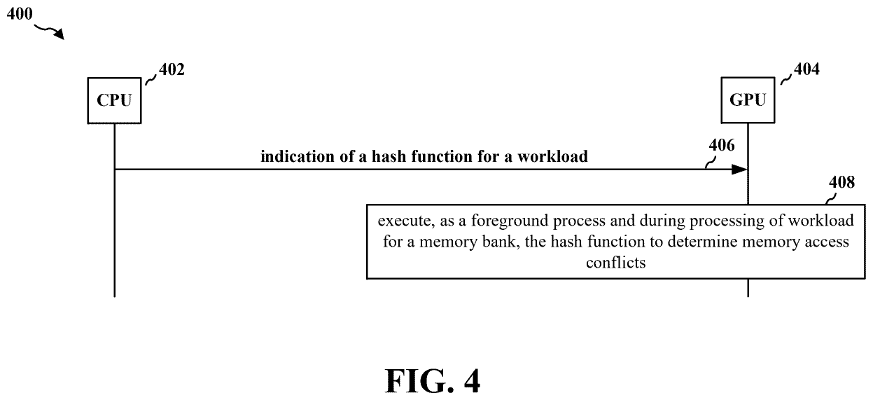

FIG. 4 illustrates an example diagram 400 of hash function utilization to determine memory access conflicts. In some examples, a CPU 402, e.g., via a driver for a workload, may provide an indication of a hash function 406 (also a “bank hash function” herein) for the workload to a GPU 404. As noted herein, the hash function 406 may be utilized to determine a number of bank access conflicts associated with a bank(s), e.g., of a memory, for concurrent accesses by fibers during workload processing, which may be performed over different workloads. The GPU 404 may be configured to execute (at 408), as a foreground process and during all processing of the workload for a memory bank, the hash function 406 to determine the memory access conflicts. Yet, a single hash function (e.g., the hash function 406) may not perform well for all workloads, or even for a single workload during its entire duration.

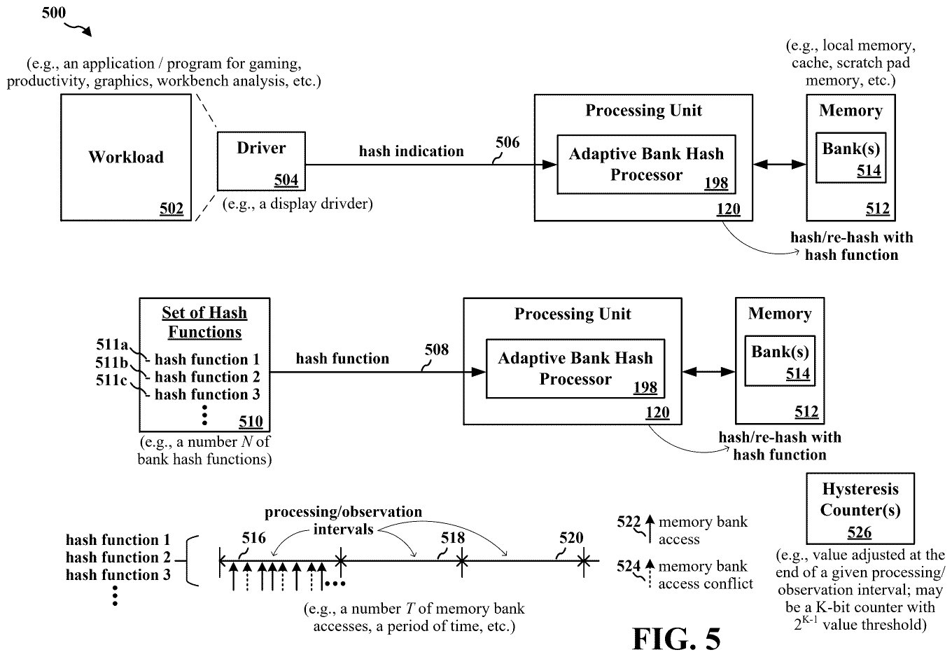

FIG. 5 illustrates an example diagram 500 of adaptive bank hash functions for workloads in accordance with one or more techniques of this disclosure. Diagram 500 is illustrated in the context of a workload 502 that is processed in association with the processing unit 120/the adaptive bank hash processor 198 (of FIG. 1) (which may comprise a wireless communication device) coupled to a memory 512 comprising a bank(s) 514. In aspects, the memory may be a local memory (e.g., a relatively small, low latency memory to access frequently used data), a cache, a scratch pad memory, etc., of the processing unit 120.

Aspects herein for adaptive bank hash functions may initially utilize a determined (e.g., selected/default) bank hash function for an initial processing of the workload 502 and/or for initiation of processing of the workload 502. In one example, a driver 504 (e.g., a display driver) associated with the workload 502 may provide a hash indication 506 that is indicative of a bank hash function to be utilized initially. In some aspects, the hash indication 506 may be indicative of a hash function 508 of a set of hash functions 510 (e.g., one or more of hash function 1 511a, hash function 2 511b, hash function 3 511c, etc. (and while three hash functions are shown, more or fewer may be included, according to aspects herein)). The processing unit 120/the adaptive bank hash processor 198 may be configured to determine the hash function 508 (e.g., one of hash function 1 511a, hash function 2 511b, hash function 3 511c, etc.) based on the hash indication 506. The hash function 508 may be associated with the memory 512 and the bank(s) 514, and the memory 512 and the bank(s) 514 may be initially hashed or may be re-hashed with the hash function 508 (e.g., prior to processing of the workload 502 and/or implementation of the hash function 508 during processing of the workload 502 when the memory 512 and the bank(s) 514 are not hashed or are currently hashed with a different hash function). During processing of the workload 502, accesses 522 to the bank(s) 514 of the memory may be made, and a determination of access conflicts 524 (e.g., one of the accesses 522 in which a conflict occurs) associated with the hash function 508 and with the memory 512/the bank(s) 514 may be made. The hash function 508 may be executed in the foreground during processing of the workload 502 to facilitate the determination of the access conflicts.

In one example, the bank hash function (e.g., the hash function 508) for the memory 512 may be selected/determined among the options included for the set of hash functions 510, and the bank hash function kept constant for the entire duration of processing of the workload 502. Such a configuration has low complexity and may be relatively simple to implement and verify and enables utilization of one of several hash functions, yet may not be as optimal as other examples herein.

In some examples, the accesses 522 (e.g., inclusive of the access conflicts 524) may be utilized as a basis for configuring processing/observation intervals (e.g., a processing/observation interval 516, a processing/observation interval 518, a processing/observation interval 520, etc.). For instance, a given processing/observation interval may be based on a number of the accesses 522 made during processing of the workload 502 (while in other aspects, periods of time and/or the like may be used). Based on the hash function 508, a number T of the access conflicts 524 that occur during a given processing/observation interval may be determined. Some aspects may enable the number of the access conflicts 524 to be utilized for updating the driver 504, and some aspects may enable the number of the access conflicts 524 to be utilized for other adaptive bank hash function operations, as discussed in further detail herein (e.g., running an additional bank hash function(s) in the background to enable implementations of different bank hash functions). Additionally, a hysteresis counter(s) 526 may be associated with the processing unit 120/the adaptive bank hash processor 198, and a value(s) thereof may be adjusted at the end of a given processing interval. The hysteresis counter(s) 526 may enable the ability to avoid changing/switching the foreground bank hash function at each processing/observation interval (e.g., frequent changing/switching), which may increase stability for the heuristics described herein for various aspects.

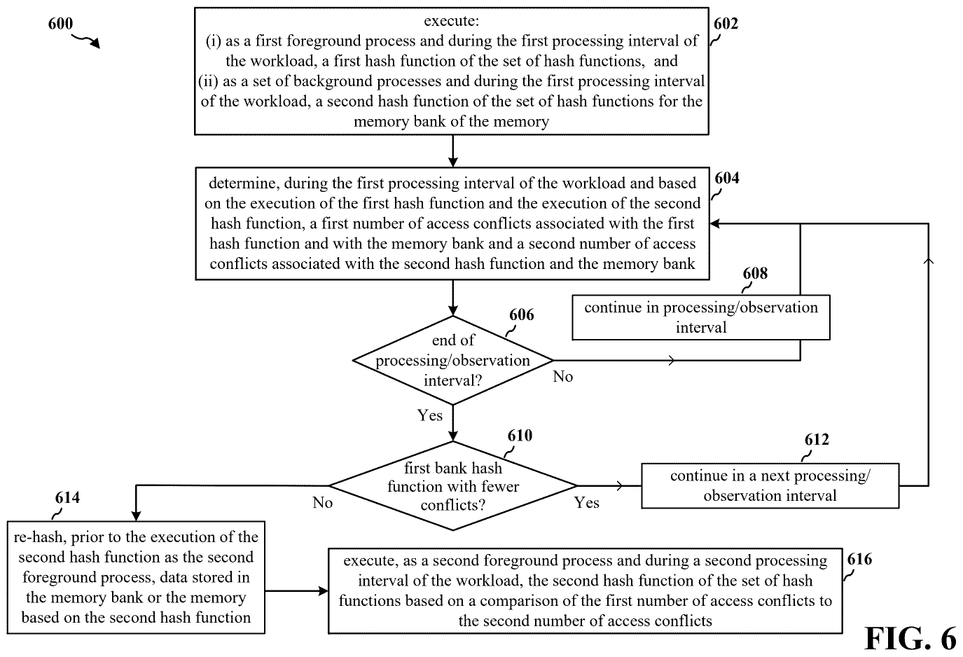

FIG. 6 illustrates an example diagram 600 of adaptive bank hash functions for workloads in accordance with one or more techniques of this disclosure. Diagram 600 may be an aspect of diagram 500 in FIG. 5. Diagram 600 shows operations that may be performed by the processing unit 120/the adaptive bank hash processor 198 (of FIG. 1) coupled to the memory 512 comprising the bank(s) 514 (of FIG. 5).

In aspects, a set of hash functions (e.g., the set of hash functions 510 in FIG. 5) may include N different bank hash functions for determination/selection. Initially, one hash function (e.g., a base/default bank hash function) may be determined/selected among the set of hash functions for utilization during processing of a workload, as described above. In some aspects, however, other bank hash functions of the set of hash functions (e.g., two others where N=3) may be executed in the background to calculate a number of bank conflicts associated therewith, but without affecting the processing of the workload. For instance, and with reference to diagram 600, the processing unit 120/the adaptive bank hash processor 198 may be configured to execute (at 602), as a first foreground process and during the first processing interval of the workload, a first hash function of the set of hash functions, and to execute (at 602), as a set of background processes and during the first processing interval of the workload, a second hash function of the set of hash functions for the memory bank of the memory.

For every processing/observation interval (e.g., as shown for processing/observation interval 516 in FIG. 5) of T memory accesses (e.g., accesses 522 in FIG. 5), access conflicts (e.g., access conflicts 524 in FIG. 5) for accesses to the bank(s) of the memory (e.g., the bank(s) 514 of the memory 512 in FIG. 5) from the current bank hash function may be compared with access conflicts of the other bank hash functions running in the background. For instance, and with reference to diagram 600, the processing unit 120/the adaptive bank hash processor 198 may be configured to determine (at 604), during the first processing interval of the workload and based on the execution of the first hash function and the execution of the second hash function, a first number of access conflicts associated with the first hash function and with the memory bank and a second number of access conflicts associated with the second hash function and the memory bank.

Aspects further provide for a determination/selection of the bank hash function with the lowest number access conflicts for a memory bank. That is, the bank hash functions executing in the foreground and in the background (e.g., at 602) may be associated with respective numbers of access conflicts for the memory bank (e.g., as determined at 604). The bank hash function with lower access conflicts during a given processing/observation interval may be determined for use (e.g., as the default hash function for a next processing/observation interval). for instance, it may be determined (at 606) if the end of a processing/observation interval has occurred. If not, the flow may continue (at 608) in the current processing/observation interval and return to 604. If not, it is determined (at 610) if the first/current bank hash function executing in the foreground has the fewest access conflicts during the current processing/observation interval. If so, the flow may continue (at 612) in a next processing/observation interval (e.g., a next determination (at 604) may be made over a next processing/observation interval with the same foreground/background bank hash functions). If not, the flow may proceed to 614, and one of the bank hash functions executing in the background during processing of the workflow may be determined as having had the fewest number of access conflicts during the first processing/observation interval—this bank hash function may be determined for foreground execution in a next processing/observation interval.

In aspects, when bank hash functions are switched for a bank(s) of a memory, existing memory data is re-hashed and associated banks are correspondingly changed to reflect the new bank hash function. For instance, and with reference to diagram 600, the processing unit 120/the adaptive bank hash processor 198 may be configured to re-hash (at 614), prior to the execution of the second hash function (e.g., a new/different hash function) as the second foreground process, data stored in the memory bank or the memory based on the second hash function. That is, the contents of the memory are associated with a first bank hash function in the first processing/observation interval, and thus, for proper operation with a new/different bank hash function in next processing/observation interval, the memory/bank(s) are re-hashed with the new/different bank hash function.

Subsequent to the re-hashing with the new/different bank hash function (e.g., at 614), processing of the workflow may continue with the new bank hash function over a next processing/observation interval. For example, the processing unit 120/the adaptive bank hash processor 198 may be configured to execute (at 616), as a second foreground process and during a second processing interval of the workload, the next/second hash function of the set of hash functions based on a comparison (e.g., at 610) of the first number of access conflicts for the first hash function to the second number of access conflicts for the next/second hash function. Additionally, the first hash function that was executed in the foreground for the first processing/observation interval may now be executed in the background with other hash functions of the set of hash functions for the next processing/observation interval.

For aspects herein, with respect to hashing/re-hashing the memory, which will consume a few cycles, the value T, which determines the processing/observation interval, may be selected/configured to improve overall performance and enable the dynamic implementation of the optimal bank hash function during run time. That is, the value T may be selected/configured such that enough memory accesses take place for the determination of access conflicts to be accurately represented, while targeting the smallest value T by which an accurate representation may be obtained.

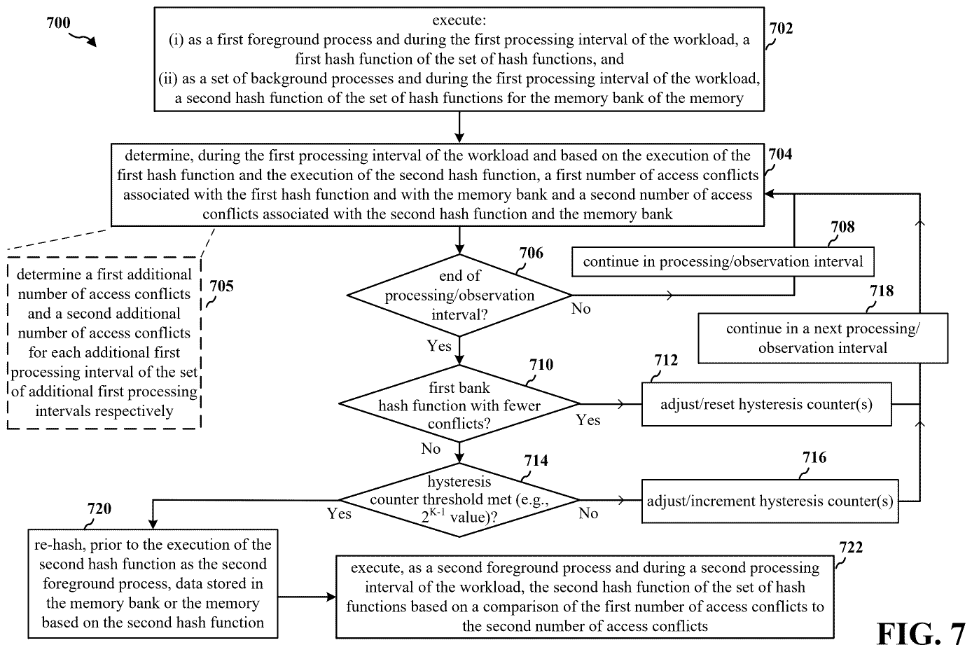

FIG. 7 illustrates an example diagram 700 of adaptive bank hash functions for workloads in accordance with one or more techniques of this disclosure. Diagram 700 may be an aspect of diagram 600 in FIG. 6 with an additional implementation of hysteric flow control over consecutive processing/observation intervals. Diagram 700 shows operations that may be performed by the processing unit 120/the adaptive bank hash processor 198 (of FIG. 1) coupled to the memory 512 comprising the bank(s) 514 (of FIG. 5).

In aspects, a set of hash functions (e.g., the set of hash functions 510) may include N different bank hash functions for determination/selection. Initially, one hash function (e.g., a base/default bank hash function) may be determined/selected among the set of hash functions for utilization during processing of a workload, as described above. In some aspects, however, other bank hash functions of the set of hash functions (e.g., two others where N=3) may be executed in the background to calculate a number of bank conflicts associated therewith, but without affecting the processing of the workload. For instance, and with reference to diagram 700, the processing unit 120/the adaptive bank hash processor 198 may be configured to execute (at 702), as a first foreground process and during the first processing interval of the workload, a first hash function of the set of hash functions, and to execute (at 702), as a set of background processes and during the first processing interval of the workload, a second hash function of the set of hash functions for the memory bank of the memory.

For every processing/observation interval (e.g., as shown for processing/observation interval 516 in FIG. 5) of T memory accesses (e.g., accesses 522 in FIG. 5), access conflicts (e.g., access conflicts 524 in FIG. 5) for accesses to the bank(s) of the memory (e.g., the bank(s) 514 of the memory 512 in FIG. 5) from the current bank hash function may be compared with access conflicts of the other bank hash functions running in the background. For instance, and with reference to diagram 700, the processing unit 120/the adaptive bank hash processor 198 may be configured to determine (at 704), during the first processing interval of the workload and based on the execution of the first hash function and the execution of the second hash function, a first number of access conflicts associated with the first hash function and with the memory bank and a second number of access conflicts associated with the second hash function and the memory bank. In some aspects, e.g., utilizing hysteresis, the determining (at 704) may include to determine (at 705) a first additional number of access conflicts and a second additional number of access conflicts for each additional first processing interval of a set of additional first processing intervals, respectively.

Aspects further provide for a determination/selection of the bank hash function with the lowest number access conflicts for a memory bank. That is, the bank hash functions executing in the foreground and in the background (e.g., at 702) may be associated with respective numbers of access conflicts for the memory bank (e.g., as determined at 704). The bank hash function with lower access conflicts during a given processing/observation interval may be determined for use (e.g., as the default hash function for a next processing/observation interval). For instance, it may be determined (at 706) if the end of a processing/observation interval has occurred. If not, the flow may continue (at 708) in the current processing/observation interval and return to 704. If not, it is determined (at 710) if the first/current bank hash function executing in the foreground has the fewest access conflicts during the current processing/observation interval. If so, the flow may proceed to adjust/reset (at 712) a hysteresis counter and may continue (at 718) in a next processing/observation interval (e.g., a next determination (at 704) may be made over a next processing/observation interval with the same foreground/background bank hash functions). If not (e.g., it is determined that a bank hash function executing in the background has the fewest memory access conflicts), the flow may proceed to determine (at 714) if a threshold condition for the hysteresis counter has been met. If it is determined (at 714) that the threshold condition for the hysteresis counter has not been met, the flow may proceed to adjust/increment (at 716) a hysteresis counter and may continue (at 718) in the next processing/observation interval (e.g., the next determination (at 704) may be made over a next processing/observation interval with the same foreground/background bank hash functions). If it is determined (at 714) that the threshold condition for the hysteresis counter has been met, the flow may proceed to 720, and one of the bank hash functions executing in the background during processing of the workflow may be determined as having had the fewest number of access conflicts during the first processing/observation interval—this bank hash function may be determined for foreground execution in a next processing/observation interval (e.g., subsequent to re-hashing the memory/memory bank(s) with the second hash function).

It should be noted that while a hysteresis counter is described for the aspects above, other aspects include multiple hysteresis counters. In such other aspects, each bank hash function executing in the background may be associated with a respective hysteresis counter. Accordingly, the determination(s) made (at 714) regarding the threshold condition for the hysteresis counter being met may be performed for the hysteresis counter that corresponds to the bank hash function executing in the background with the fewest access conflicts. Likewise, the adjustment/reset (at 712) may be performed for each hysteresis counter associated with a background bank hash function (e.g., if the foreground bank hash function performs the best (i.e., the foreground bank hash function is the most suitable, the foreground bank hash function has the lowest number of conflicts, the foreground bank hash function is executed the fastest, etc.), hysteresis counters of other bank hash functions may be reset). Similarly, the adjustment/increment (at 716) may be performed for each hysteresis counter associated with a background bank hash function (e.g., if a background bank hash function performs the best, the hysteresis counter of the best-performing bank hash function may be incremented, while hysteresis counters of other bank hash functions executing in the background may be reset). In some aspects, adjusting the value of the hysteresis counter may be based on comparisons of the first number of access conflicts to the second number of access conflicts and additional comparisons of the first additional number of access conflicts and the second additional number of access conflicts for each additional first processing interval of the set of additional first processing intervals. Aspects herein may provide for threshold conditions of any positive integer value (e.g., 1, 2, 3, . . . , etc.), and also may provide for K-bit hysteresis counters. In some aspects for K-bit hysteresis counters, a hysteresis counter value of 2^{K-1} for the K-bit hysteresis counter may be indicative of a threshold condition being met (e.g., where K=2, a value of 2^{K-1}=2, for K=3, a value of 2^{K-1}=4, for K=4, a value of 2^{K-1}=8, etc.). The described hysteresis counters enable the ability to avoid changing/switching the foreground bank hash function at each processing/observation interval (e.g., frequent changing/switching), which may increase stability for the heuristics described herein for various aspects.

In aspects, when bank hash functions are switched for a bank(s) of a memory, existing memory data is re-hashed and associated banks are correspondingly changed to reflect the new bank hash function. For instance, and with reference to diagram 700, the processing unit 120/the adaptive bank hash processor 198 may be configured to re-hash (at 720), prior to the execution of the second hash function (e.g., a new/different hash function) as the second foreground process, data stored in the memory bank or the memory based on the second hash function. That is, the contents of the memory are associated with a first bank hash function in the first processing/observation interval, and thus, for proper operation with a new/different bank hash function in next processing/observation interval, the memory/bank(s) are re-hashed with the new/different bank hash function.

Subsequent to the re-hashing with the new/different bank hash function (e.g., at 720), processing of the workflow may continue with the new bank hash function over a next processing/observation interval. For example, the processing unit 120/the adaptive bank hash processor 198 may be configured to execute (at 722), as a second foreground process and during a second processing interval of the workload, the next/second hash function of the set of hash functions based on a comparison (e.g., at 710) of the first number of access conflicts for the first hash function to the second number of access conflicts for the next/second hash function and/or based on the threshold condition for the corresponding hysteresis counter being met. Additionally, the first hash function that was executed in the foreground for the first processing/observation interval may now be executed in the background with other hash functions of the set of hash functions for the next processing/observation interval.

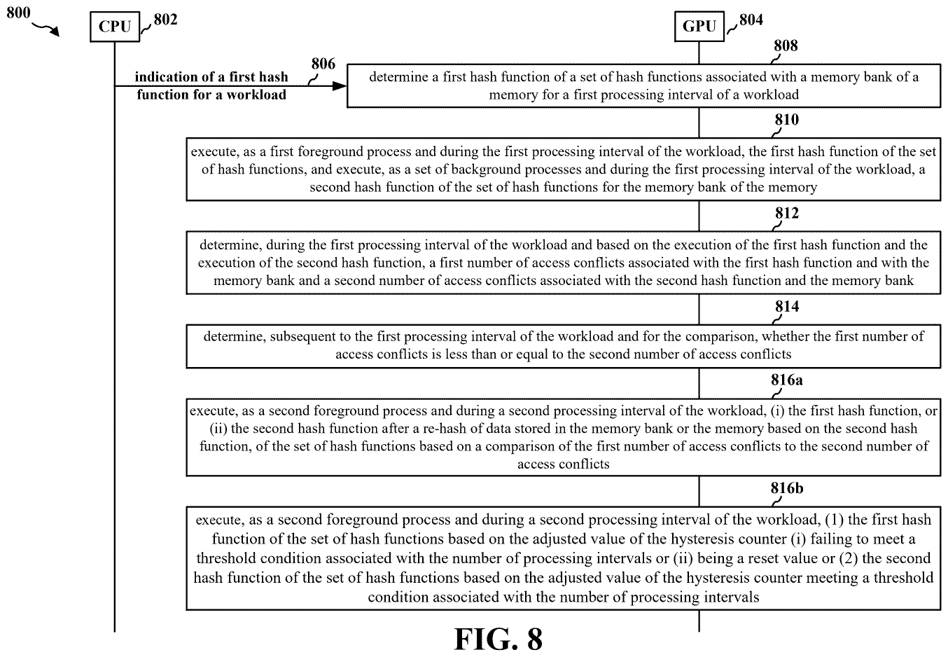

FIG. 8 is a call flow diagram 800 illustrating example communications between a CPU 802 and a graphics processor 804 in accordance with one or more techniques of this disclosure. In aspects, call flow diagram 800 is described for dynamic bank hash functions. In an example, the graphics processor 804 may be or include a GPU and/or the processing unit 120.

The graphics processor 804 may be configured to determine (at 808) a first hash function of a set of hash functions associated with a memory bank of a memory for a first processing interval of a workload. In aspects, the first hash function may be based on a hash indication 806 of the first hash function for the workload. The graphics processor 804 may be configured to receive, and the CPU 802 may be configured to provide prior to execution of the first hash function, the hash indication 806, which may indicate the first hash function of the set of hash functions. In some aspects, the hash indication 806 may be associated with a driver (e.g., a display driver) of the workload. In aspects, a length of a given processing interval may be based on a resource utilization metric associated with a hashing of the memory or the memory bank subsequent to an initiation of the processing interval. In some aspects, the length of the first processing interval is based on a number of memory bank accesses to the memory bank subsequent to an initiation of the first processing interval of the workload. In some aspects, the memory may be a local memory, a cache, a scratch pad memory, and/or the like, that is coupled to the graphics processor 804.

At 810, the graphics processor 804 may be configured to execute, as a first foreground process and during the first processing interval of the workload, the first hash function of the set of hash functions, and to execute, as a set of background processes and during the first processing interval of the workload, a second hash function of the set of hash functions for the memory bank of the memory. In aspects, the first processing interval may include/comprise a set of additional first processing intervals of the workload (e.g., a second processing interval, a third processing interval, etc.). The first processing interval and at least one of the set of additional first processing intervals may be separate from each other, and a value of a hysteresis counter may correspond to endings of a number of processing intervals comprising the first processing interval and the set of additional first processing intervals. That is, a hysteresis counter value may be adjusted (e.g., incremented, reset, etc.) at the end of a given processing interval.

At 812, the graphics processor 804 may be configured to determine, during the first processing interval of the workload and based on the execution of the first hash function and the execution of the second hash function, a first number of access conflicts associated with the first hash function and with the memory bank and a second number of access conflicts associated with the second hash function and the memory bank. In aspects, to determine the first number of access conflicts and the second number of access conflicts, the graphics processor 804 may be configured to determine a first additional number of access conflicts and a second additional number of access conflicts for each additional first processing interval of the set of additional first processing intervals respectively, and/or to adjust the value of the hysteresis counter based on first comparisons of the first number of access conflicts to the second number of access conflicts and additional comparisons of the first additional number of access conflicts and the second additional number of access conflicts for each additional first processing interval of the set of additional first processing intervals. In aspects, the hysteresis counter may be a K-bit hysteresis counter, and a hysteresis counter value of 2^{K-1} of the K-bit hysteresis counter may meet a threshold condition associated with the number of processing intervals.

At 814, the graphics processor 804 may be configured to determine, subsequent to the first processing interval of the workload and for the comparison, whether the first number of access conflicts is less than or equal to the second number of access conflicts. That is, the graphics processor 804 may be configured to determine which bank hash function, executing across the foreground and the background during processing of the workload, is associated with the fewest memory access conflicts.

At 816a, the graphics processor 804 may be configured to execute, as a second foreground process and during a second processing interval of the workload, the first hash function or the second hash function (e.g., after a re-hash of data stored in the memory bank or the memory based on the second hash function) of the set of hash functions based on a comparison of the first number of access conflicts to the second number of access conflicts. In aspects, the graphics processor 804 may be configured to hash (and/or re-hash), prior to the execution of the second hash function as the second foreground process, data stored in the memory bank or the memory based on the second hash function, and may hash/re-hash the data stored in the memory bank or the memory based on the first bank hash function being switched to another bank hash function.

At 816b, the graphics processor 804 may be configured to execute, as a second foreground process and during a second processing interval of the workload, (1) the first hash function of the set of hash functions based on the adjusted value of the hysteresis counter (i) failing to meet a threshold condition associated with the number of processing intervals or (ii) being a reset value or (2) the second hash function of the set of hash functions based on the adjusted value of the hysteresis counter meeting a threshold condition associated with the number of processing intervals.

In aspects, the graphics processor 804 may be configured to execute (at 816a) based on a hysteresis counter not being implemented, or may be configured to execute (at 816b) based on a hysteresis counter being implemented.

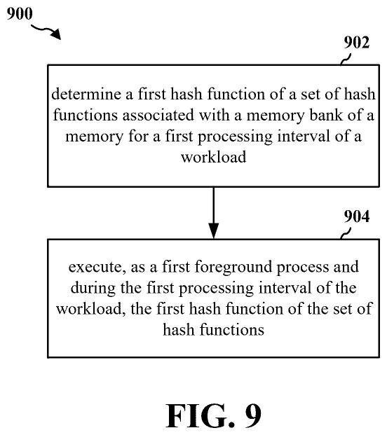

FIG. 9 is a flowchart 900 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-8.

At 902, the apparatus may determine a first hash function of a set of hash functions associated with a memory bank of a memory for a first processing interval of a workload. For example, referring to FIG. 8, the graphics processor 804 may be configured to determine (at 808) a first hash function (e.g., 508, 511a, 511b, 511c in FIG. 5) of a set of hash functions (e.g., 510 in FIG. 5) associated with a memory bank (e.g., 514 in FIG. 5) of a memory (e.g., 512 in FIG. 5) for a first processing interval (e.g., 516, 518, 520 in FIG. 5) of a workload (e.g., 502 in FIG. 5). In aspects, the first hash function (e.g., 508, 511a, 511b, 511c in FIG. 5) may be based on a hash indication 806 (e.g., 506 in FIG. 5) of the first hash function (e.g., 508, 511a, 511b, 511c in FIG. 5) for the workload (e.g., 502 in FIG. 5). The graphics processor 804 may be configured to receive, and the CPU 802 may be configured to provide prior to execution of the first hash function (e.g., 508, 511a, 511b, 511c in FIG. 5), the hash indication 806 (e.g., 506 in FIG. 5), which may indicate the first hash function (e.g., 508, 511a, 511b, 511c in FIG. 5) of the set of hash functions (e.g., 510 in FIG. 5). In some aspects, the hash indication 806 (e.g., 506 in FIG. 5) may be associated with a driver (e.g., 504 in FIG. 5) (e.g., a display driver) of the workload (e.g., 502 in FIG. 5). In aspects, a length of a given processing interval (e.g., 516, 518, 520 in FIG. 5) may be based on a resource utilization metric associated with a hashing of the memory (e.g., 512 in FIG. 5) or the memory bank (e.g., 514 in FIG. 5) subsequent to an initiation of the processing interval (e.g., 516, 518, 520 in FIG. 5). In some aspects, the length of the first processing interval (e.g., 516, 518, 520 in FIG. 5) is based on a number of memory bank accesses (e.g., 522 in FIG. 5) to the memory bank (e.g., 514 in FIG. 5) subsequent to an initiation of the first processing interval (e.g., 516, 518, 520 in FIG. 5) of the workload (e.g., 502 in FIG. 5). In some aspects, the memory (e.g., 512 in FIG. 5) may be a local memory, a cache, a scratch pad memory, and/or the like, that is coupled to the graphics processor 804.

At 904, the apparatus may execute, as a first foreground process and during the first processing interval of the workload, the first hash function of the set of hash functions For example, referring to FIG. 8, at 810, the graphics processor 804 may be configured to execute (e.g., 602 in FIG. 6; 702 in FIG. 7), as a first foreground process and during the first processing interval (e.g., 516, 518, 520 in FIG. 5) of the workload (e.g., 502 in FIG. 5), the first hash function (e.g., 508, 511a, 511b, 511c in FIG. 5) of the set of hash functions (e.g., 510 in FIG. 5). The graphics processor 804 may also be configured to execute (e.g., 602 in FIG. 6; 702 in FIG. 7), as a set of background processes and during the first processing interval (e.g., 516, 518, 520 in FIG. 5) of the workload (e.g., 502 in FIG. 5), a second hash function of the set of hash functions (e.g., 510 in FIG. 5) for the memory bank (e.g., 514 in FIG. 5) of the memory (e.g., 512 in FIG. 5). In aspects, the first processing interval may include/comprise a set of additional first processing intervals (e.g., 516, 518, 520 in FIG. 5) of the workload (e.g., 502 in FIG. 5) (e.g., a second processing interval, a third processing interval, etc.). The first processing interval (e.g., 516, 518, 520 in FIG. 5) and at least one of the set of additional first processing intervals (e.g., 516, 518, 520 in FIG. 5) may be separate from each other, and a value of a hysteresis counter (e.g., 526 in FIG. 5) may correspond to endings of a number of processing intervals (e.g., 516, 518, 520 in FIG. 5) comprising the first processing interval (e.g., 516, 518, 520 in FIG. 5) and the set of additional first processing intervals (e.g., 516, 518, 520 in FIG. 5). That is, a hysteresis counter (e.g., 526 in FIG. 5) value may be adjusted (e.g., incremented, reset, etc.) (e.g., 712, 716 in FIG. 7) at the end of a given processing interval (e.g., 516, 518, 520 in FIG. 5).

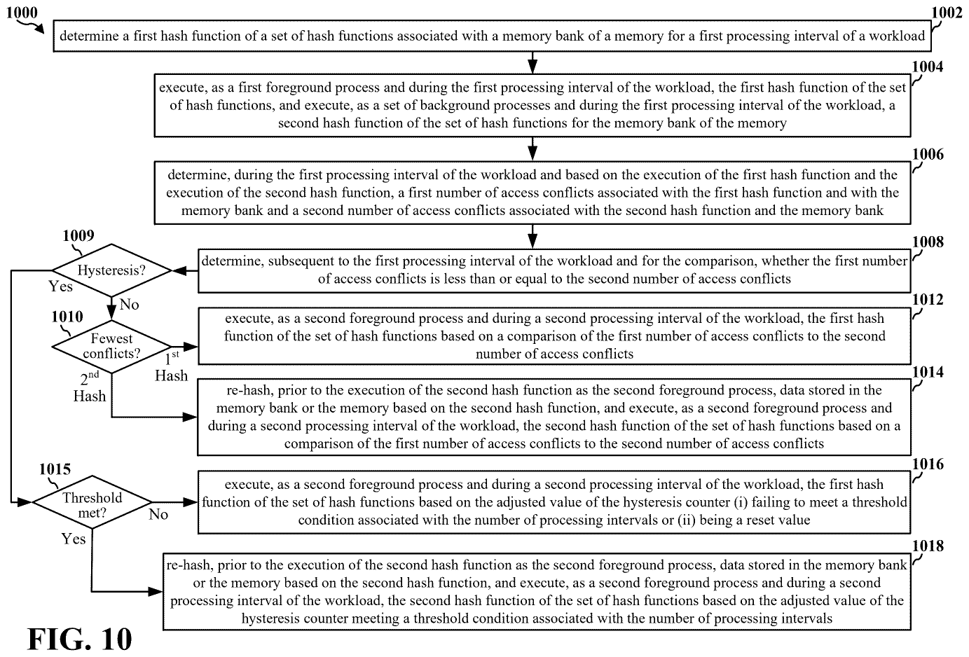

FIG. 10 is a flowchart 1000 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-8.

At 1002, the apparatus may determine a first hash function of a set of hash functions associated with a memory bank of a memory for a first processing interval of a workload. For example, referring to FIG. 8, the graphics processor 804 may be configured to determine (at 808) a first hash function (e.g., 508, 511a, 511b, 511c in FIG. 5) of a set of hash functions (e.g., 510 in FIG. 5) associated with a memory bank (e.g., 514 in FIG. 5) of a memory (e.g., 512 in FIG. 5) for a first processing interval (e.g., 516, 518, 520 in FIG. 5) of a workload (e.g., 502 in FIG. 5). In aspects, the first hash function (e.g., 508, 511a, 511b, 511c in FIG. 5) may be based on a hash indication 806 (e.g., 506 in FIG. 5) of the first hash function (e.g., 508, 511a, 511b, 511c in FIG. 5) for the workload (e.g., 502 in FIG. 5). The graphics processor 804 may be configured to receive, and the CPU 802 may be configured to provide prior to execution of the first hash function (e.g., 508, 511a, 511b, 511c in FIG. 5), the hash indication 806 (e.g., 506 in FIG. 5), which may indicate the first hash function (e.g., 508, 511a, 511b, 511c in FIG. 5) of the set of hash functions (e.g., 510 in FIG. 5). In some aspects, the hash indication 806 (e.g., 506 in FIG. 5) may be associated with a driver (e.g., 504 in FIG. 5) (e.g., a display driver) of the workload (e.g., 502 in FIG. 5). In aspects, a length of a given processing interval (e.g., 516, 518, 520 in FIG. 5) may be based on a resource utilization metric associated with a hashing of the memory (e.g., 512 in FIG. 5) or the memory bank (e.g., 514 in FIG. 5) subsequent to an initiation of the processing interval (e.g., 516, 518, 520 in FIG. 5). In some aspects, the length of the first processing interval (e.g., 516, 518, 520 in FIG. 5) is based on a number of memory bank accesses (e.g., 522 in FIG. 5) to the memory bank (e.g., 514 in FIG. 5) subsequent to an initiation of the first processing interval (e.g., 516, 518, 520 in FIG. 5) of the workload (e.g., 502 in FIG. 5). In some aspects, the memory (e.g., 512 in FIG. 5) may be a local memory, a cache, a scratch pad memory, and/or the like, that is coupled to the graphics processor 804.

At 1004, the apparatus may execute, as a first foreground process and during the first processing interval of the workload, the first hash function of the set of hash functions, and execute, as a set of background processes and during the first processing interval of the workload, a second hash function of the set of hash functions for the memory bank of the memory. For example, referring to FIG. 8, at 810, the graphics processor 804 may be configured to execute (e.g., 602 in FIG. 6; 702 in FIG. 7), as a first foreground process and during the first processing interval (e.g., 516, 518, 520 in FIG. 5) of the workload (e.g., 502 in FIG. 5), the first hash function (e.g., 508, 511a, 511b, 511c in FIG. 5) of the set of hash functions (e.g., 510 in FIG. 5), and to execute (e.g., 602 in FIG. 6; 702 in FIG. 7), as a set of background processes and during the first processing interval (e.g., 516, 518, 520 in FIG. 5) of the workload (e.g., 502 in FIG. 5), a second hash function of the set of hash functions (e.g., 510 in FIG. 5) for the memory bank (e.g., 514 in FIG. 5) of the memory (e.g., 512 in FIG. 5). In aspects, the first processing interval may include/comprise a set of additional first processing intervals (e.g., 516, 518, 520 in FIG. 5) of the workload (e.g., 502 in FIG. 5) (e.g., a second processing interval, a third processing interval, etc.). The first processing interval (e.g., 516, 518, 520 in FIG. 5) and at least one of the set of additional first processing intervals (e.g., 516, 518, 520 in FIG. 5) may be separate from each other, and a value of a hysteresis counter (e.g., 526 in FIG. 5) may correspond to endings of a number of processing intervals (e.g., 516, 518, 520 in FIG. 5) comprising the first processing interval (e.g., 516, 518, 520 in FIG. 5) and the set of additional first processing intervals (e.g., 516, 518, 520 in FIG. 5). That is, a hysteresis counter (e.g., 526 in FIG. 5) value may be adjusted (e.g., incremented, reset, etc.) (e.g., 712, 716 in FIG. 7) at the end of a given processing interval (e.g., 516, 518, 520 in FIG. 5).

At 1006, the apparatus may determine, during the first processing interval of the workload and based on the execution of the first hash function and the execution of the second hash function, a first number of access conflicts associated with the first hash function and with the memory bank and a second number of access conflicts associated with the second hash function and the memory bank. For example, referring to FIG. 8, at 812, the graphics processor 804 may be configured to determine (e.g., 704 in FIG. 7), during the first processing interval (e.g., 516, 518, 520 in FIG. 5) of the workload (e.g., 502 in FIG. 5) and based on the execution (e.g., 602 in FIG. 6; 702 in FIG. 7) of the first hash function (e.g., 508, 511a, 511b, 511c in FIG. 5) and the execution (e.g., 602 in FIG. 6; 702 in FIG. 7) of the second hash function (e.g., 508, 511a, 511b, 511c in FIG. 5), a first number of access conflicts (e.g., 524 in FIG. 5) associated with the first hash function (e.g., 508, 511a, 511b, 511c in FIG. 5) and with the memory bank (e.g., 514 in FIG. 5) and a second number of access conflicts (e.g., 524 in FIG. 5) associated with the second hash function (e.g., 508, 511a, 511b, 511c in FIG. 5) and the memory bank (e.g., 514 in FIG. 5). In aspects, to determine (e.g., 704 in FIG. 7) the first number of access conflicts (e.g., 524 in FIG. 5) and the second number of access conflicts (e.g., 524 in FIG. 5), the graphics processor 804 may be configured to determine (e.g., 705 in FIG. 7) a first additional number of access conflicts (e.g., 524 in FIG. 5) and a second additional number of access conflicts (e.g., 524 in FIG. 5) for each additional first processing interval (e.g., 516, 518, 520 in FIG. 5) of the set of additional first processing intervals (e.g., 516, 518, 520 in FIG. 5) respectively, and/or to adjust (e.g., 712, 716 in FIG. 7) the value of the hysteresis counter (e.g., 526 in FIG. 5) based on first comparisons of the first number of access conflicts (e.g., 524 in FIG. 5) to the second number of access conflicts (e.g., 524 in FIG. 5) and additional comparisons of the first additional number of access conflicts (e.g., 524 in FIG. 5) and the second additional number of access conflicts (e.g., 524 in FIG. 5) for each additional first processing interval (e.g., 516, 518, 520 in FIG. 5) of the set of additional first processing intervals (e.g., 516, 518, 520 in FIG. 5). In aspects, the hysteresis counter (e.g., 526 in FIG. 5) may be a K-bit hysteresis counter (e.g., 526 in FIG. 5), and a hysteresis counter value of 2^{K-1} of the K-bit hysteresis counter (e.g., 526 in FIG. 5) may meet a threshold condition associated with the number of processing intervals (e.g., 516, 518, 520 in FIG. 5).

At 1008, the apparatus may determine, subsequent to the first processing interval of the workload and for the comparison, whether the first number of access conflicts is less than or equal to the second number of access conflicts. For example, referring to FIG. 8, at 814, the graphics processor 804 may be configured to determine, subsequent to the first processing interval (e.g., 516, 518, 520 in FIG. 5) of the workload (e.g., 502 in FIG. 5) and for the comparison, whether the first number of access conflicts (e.g., 524 in FIG. 5) is less than or equal to the second number of access conflicts (e.g., 524 in FIG. 5). That is, the graphics processor 804 may be configured to determine which bank hash function (e.g., 508, 511a, 511b, 511c in FIG. 5), executing (e.g., 602 in FIG. 6; 702 in FIG. 7) across the foreground and the background during processing of the workload (e.g., 502 in FIG. 5), is associated with the fewest memory access conflicts (e.g., 524 in FIG. 5).

At 1009, the apparatus may determine if hysteresis is being utilized. If so, the flow may continue to 1015; if not, the flow may continue to 1010. For example, referring to FIG. 8, the graphics processor 804 may be configured to execute (at 816a) (e.g., 602, 616 in FIG. 6) based on a hysteresis counter (e.g., 526 in FIG. 5) not being implemented, or may be configured to execute (at 816b) (e.g., 702, 722 in FIG. 7) based on a hysteresis counter (e.g., 526 in FIG. 5) being implemented.

At 1010, the apparatus may determine to execute (e.g., 602 in FIG. 6; 702 in FIG. 7) a current hash function (e.g., 508, 511a, 511b, 511c in FIG. 5) as a foreground processor or to execute (e.g., 616 in FIG. 6; 722 in FIG. 7) a different/new hash function (e.g., 508, 511a, 511b, 511c in FIG. 5) as the foreground process based on the determination (e.g., 704/705 in FIG. 7) for numbers of access conflicts (e.g., 524 in FIG. 5) (e.g., at 1008). If the first bank hash function (e.g., 508, 511a, 511b, 511c in FIG. 5) (e.g., that was currently executing (e.g., 602 in FIG. 6; 702 in FIG. 7) in the foreground) has the fewest access conflicts (e.g., 524 in FIG. 5), or an equal number of access conflicts (e.g., 524 in FIG. 5) as the second bank hash function (e.g., 508, 511a, 511b, 511c in FIG. 5), in aspects, the flow may continue to 1012; if the second bank hash function (e.g., 508, 511a, 511b, 511c in FIG. 5) has the fewest number of access conflicts (e.g., 524 in FIG. 5), the foreground bank hash function (e.g., 508, 511a, 511b, 511c in FIG. 5) may be switched (e.g., 616 in FIG. 6; 720 in FIG. 7), and the flow may continue to 1014.

At 1012, the apparatus may execute, as a second foreground process and during a second processing interval of the workload, the first hash function of the set of hash functions based on a comparison of the first number of access conflicts to the second number of access conflicts. For example, referring to FIG. 8, at 816a, the graphics processor 804 may be configured to execute (e.g., 602 in FIG. 6; 702 in FIG. 7), as a second foreground process and during a second processing interval (e.g., 516, 518, 520 in FIG. 5) of the workload (e.g., 502 in FIG. 5), the first hash function (e.g., 508, 511a, 511b, 511c in FIG. 5) or to execute (e.g., 616 in FIG. 6; 722 in FIG. 7) the second hash function (e.g., 508, 511a, 511b, 511c in FIG. 5) (e.g., after a re-hash (e.g., 614 in FIG. 6; 720 in FIG. 7) of data stored in the memory bank (e.g., 514 in FIG. 5) or the memory (e.g., 512 in FIG. 5) based on the second hash function (e.g., 508, 511a, 511b, 511c in FIG. 5)) of the set of hash functions (e.g., 510 in FIG. 5) based on a comparison of the first number of access conflicts (e.g., 524 in FIG. 5) to the second number of access conflicts (e.g., 524 in FIG. 5). In aspects, the graphics processor 804 may be configured to hash (and/or re-hash (e.g., 614 in FIG. 6; 720 in FIG. 7)), prior to the execution (e.g., 616 in FIG. 6; 722 in FIG. 7) of the second hash function (e.g., 508, 511a, 511b, 511c in FIG. 5) as the second foreground process, data stored in the memory bank (e.g., 514 in FIG. 5) or the memory (e.g., 512 in FIG. 5) based on the second hash function (e.g., 508, 511a, 511b, 511c in FIG. 5), and may hash/re-hash (e.g., 614 in FIG. 6; 720 in FIG. 7) the data stored in the memory bank (e.g., 514 in FIG. 5) or the memory (e.g., 512 in FIG. 5) based on the first bank hash function (e.g., 508, 511a, 511b, 511c in FIG. 5) being switched (e.g., 616 in FIG. 6; 722 in FIG. 7) to another bank hash function (e.g., 508, 511a, 511b, 511c in FIG. 5). In aspects, the graphics processor 804 may be configured to execute (at 816a) (e.g., 602, 616 in FIG. 7) based on a hysteresis counter (e.g., 526 in FIG. 5) not being implemented.

At 1014, the apparatus may re-hash, prior to the execution of the second hash function as the second foreground process, data stored in the memory bank or the memory based on the second hash function, and execute, as a second foreground process and during a second processing interval of the workload, the second hash function of the set of hash functions based on a comparison of the first number of access conflicts to the second number of access conflicts. For example, referring to FIG. 8, at 816a, the graphics processor 804 may be configured to execute (e.g., 602 in FIG. 6; 702 in FIG. 7), as a second foreground process and during a second processing interval (e.g., 516, 518, 520 in FIG. 5) of the workload (e.g., 502 in FIG. 5), the first hash function (e.g., 508, 511a, 511b, 511c in FIG. 5) or to execute (e.g., 616 in FIG. 6; 722 in FIG. 7) the second hash function (e.g., 508, 511a, 511b, 511c in FIG. 5) (e.g., after a re-hash (e.g., 614 in FIG. 6; 720 in FIG. 7) of data stored in the memory bank (e.g., 514 in FIG. 5) or the memory (e.g., 512 in FIG. 5) based on the second hash function (e.g., 508, 511a, 511b, 511c in FIG. 5)) of the set of hash functions (e.g., 510 in FIG. 5) based on a comparison of the first number of access conflicts (e.g., 524 in FIG. 5) to the second number of access conflicts (e.g., 524 in FIG. 5). In aspects, the graphics processor 804 may be configured to hash (and/or re-hash (e.g., 614 in FIG. 6; 720 in FIG. 7)), prior to the execution (e.g., 616 in FIG. 6; 722 in FIG. 7) of the second hash function (e.g., 508, 511a, 511b, 511c in FIG. 5) as the second foreground process, data stored in the memory bank (e.g., 514 in FIG. 5) or the memory (e.g., 512 in FIG. 5) based on the second hash function (e.g., 508, 511a, 511b, 511c in FIG. 5), and may hash/re-hash (e.g., 614 in FIG. 6; 720 in FIG. 7) the data stored in the memory bank (e.g., 514 in FIG. 5) or the memory (e.g., 512 in FIG. 5) based on the first bank hash function (e.g., 508, 511a, 511b, 511c in FIG. 5) being switched (e.g., 616 in FIG. 6; 722 in FIG. 7) to another bank hash function (e.g., 508, 511a, 511b, 511c in FIG. 5). In aspects, the graphics processor 804 may be configured to execute (at 816a) (e.g., 602, 616 in FIG. 7) based on a hysteresis counter (e.g., 526 in FIG. 5) not being implemented.

At 1015, the apparatus may determine if a hysteresis threshold has been met or not for a hysteresis counter (e.g., 526 in FIG. 5). For example, referring to FIG. 7, in some aspects, e.g., utilizing hysteresis, the determining (at 704) may include to determine (at 705) a first additional number of access conflicts (e.g., 524 in FIG. 5) and a second additional number of access conflicts (e.g., 524 in FIG. 5) for each additional first processing interval (e.g., 516, 518, 520 in FIG. 5) of a set of additional first processing intervals (e.g., 516, 518, 520 in FIG. 5), respectively. Aspects further provide for a determination/selection of the bank hash function (e.g., 508, 511a, 511b, 511c in FIG. 5) with the lowest number access conflicts (e.g., 524 in FIG. 5) for a memory bank (e.g., 514 in FIG. 5). That is, the bank hash functions (e.g., 508, 511a, 511b, 511c in FIG. 5) executing (e.g., 602 in FIG. 6; 702 in FIG. 7) in the foreground and in the background (e.g., at 702) may be associated with respective numbers of access conflicts (e.g., 524 in FIG. 5) for the memory bank (e.g., 514 in FIG. 5) (e.g., as determined at 704). The bank hash function (e.g., 508, 511a, 511b, 511c in FIG. 5) with lower access conflicts (e.g., 524 in FIG. 5) during a given processing/observation interval (e.g., 516, 518, 520 in FIG. 5) may be determined for use (e.g., as the default hash function (e.g., 508, 511a, 511b, 511c in FIG. 5) for a next processing/observation interval (e.g., 516, 518, 520 in FIG. 5)). For instance, it may be determined (at 706) if the end of a processing/observation interval (e.g., 516, 518, 520 in FIG. 5) has occurred. If not, the flow may continue (at 708) in the current processing/observation interval (e.g., 516, 518, 520 in FIG. 5) and return to 704. If not, it is determined (at 710) if the first/current bank hash function (e.g., 508, 511a, 511b, 511c in FIG. 5) executing (e.g., 602 in FIG. 6; 702 in FIG. 7) in the foreground has the fewest access conflicts (e.g., 524 in FIG. 5) during the current processing/observation interval (e.g., 516, 518, 520 in FIG. 5). If so, the flow may proceed to adjust/reset (at 712) a hysteresis counter (e.g., 526 in FIG. 5) and may continue (at 718) in a next processing/observation interval (e.g., 516, 518, 520 in FIG. 5) (e.g., a next determination (at 704) may be made over a next processing/observation interval (e.g., 516, 518, 520 in FIG. 5) with the same foreground/background bank hash functions (e.g., 508, 511a, 511b, 511c in FIG. 5)). If not (e.g., it is determined that a bank hash function (e.g., 508, 511a, 511b, 511c in FIG. 5) executing (e.g., 602 in FIG. 6; 702 in FIG. 7) in the background has the fewest memory access conflicts (e.g., 524 in FIG. 5)), the flow may proceed to determine (at 714) if a threshold condition for the hysteresis counter (e.g., 526 in FIG. 5) has been met. If it is determined (at 714) that the threshold condition for the hysteresis counter (e.g., 526 in FIG. 5) has not been met, the flow may proceed to adjust/increment (at 716) a hysteresis counter (e.g., 526 in FIG. 5) and may continue (at 718) in the next processing/observation interval (e.g., 516, 518, 520 in FIG. 5) (e.g., the next determination (at 704) may be made over a next processing/observation interval (e.g., 516, 518, 520 in FIG. 5) with the same foreground/background bank hash functions (e.g., 508, 511a, 511b, 511c in FIG. 5)). If it is determined (at 714) that the threshold condition for the hysteresis counter (e.g., 526 in FIG. 5) has been met, the flow may proceed to 720, and one of the bank hash functions (e.g., 508, 511a, 511b, 511c in FIG. 5) executing (e.g., 602 in FIG. 6; 702 in FIG. 7) in the background during processing of the workflow may be determined as having had the fewest number of access conflicts (e.g., 524 in FIG. 5) during the first processing/observation interval (e.g., 516, 518, 520 in FIG. 5)—this bank hash function (e.g., 508, 511a, 511b, 511c in FIG. 5) may be determined for foreground execution (e.g., 602, 616 in FIG. 6; 702, 722 in FIG. 7) in a next processing/observation interval (e.g., 516, 518, 520 in FIG. 5). It should be noted that while a hysteresis counter (e.g., 526 in FIG. 5) is described for the aspects above, other aspects include multiple hysteresis counters (e.g., 526 in FIG. 5). In such other aspects, each bank hash function (e.g., 508, 511a, 511b, 511c in FIG. 5) executing (e.g., 602 in FIG. 6; 702 in FIG. 7) in the background may be associated with a respective hysteresis counter (e.g., 526 in FIG. 5). Accordingly, the determination(s) made (at 714) regarding the threshold condition for the hysteresis counter (e.g., 526 in FIG. 5) being met may be performed for the hysteresis counter (e.g., 526 in FIG. 5) that corresponds to the bank hash function (e.g., 508, 511a, 511b, 511c in FIG. 5) executing (e.g., 602 in FIG. 6; 702 in FIG. 7) in the background with the fewest access conflicts (e.g., 524 in FIG. 5). Likewise, the adjustment/reset (at 712) may be performed for each hysteresis counter (e.g., 526 in FIG. 5) associated with a background bank hash function (e.g., 508, 511a, 511b, 511c in FIG. 5) (e.g., if the foreground bank hash function (e.g., 508, 511a, 511b, 511c in FIG. 5) performs the best, hysteresis counters (e.g., 526 in FIG. 5) of other bank hash functions (e.g., 508, 511a, 511b, 511c in FIG. 5) may be reset). Similarly, the adjustment/increment (at 716) may be performed for each hysteresis counter (e.g., 526 in FIG. 5) associated with a background bank hash function (e.g., 508, 511a, 511b, 511c in FIG. 5) (e.g., if a background bank hash function (e.g., 508, 511a, 511b, 511c in FIG. 5) performs the best, the hysteresis counter (e.g., 526 in FIG. 5) of the best-performing bank hash function (e.g., 508, 511a, 511b, 511c in FIG. 5) may be incremented, while hysteresis counters (e.g., 526 in FIG. 5) of other bank hash functions (e.g., 508, 511a, 511b, 511c in FIG. 5) executing (e.g., 602 in FIG. 6; 702 in FIG. 7) in the background may be reset). In some aspects, adjusting (e.g., 712, 716 in FIG. 7) the value of the hysteresis counter (e.g., 526 in FIG. 5) may be based on comparisons of the first number of access conflicts (e.g., 524 in FIG. 5) to the second number of access conflicts (e.g., 524 in FIG. 5) and additional comparisons of the first additional number of access conflicts (e.g., 524 in FIG. 5) and the second additional number of access conflicts (e.g., 524 in FIG. 5) for each additional first processing interval (e.g., 516, 518, 520 in FIG. 5) of the set of additional first processing intervals (e.g., 516, 518, 520 in FIG. 5). Aspects herein may provide for threshold conditions of any positive integer value (e.g., 1, 2, 3, . . . , etc.), and also may provide for K-bit hysteresis counters (e.g., 526 in FIG. 5). In some aspects for K-bit hysteresis counters (e.g., 526 in FIG. 5), a hysteresis counter value of 2^{K-1} for the K-bit hysteresis counter (e.g., 526 in FIG. 5) may be indicative of a threshold condition being met (e.g., where K=2, a value of 2^{K-1}=2, for K=3, a value of 2^{K-1}=4, for K=4, a value of 2^{K-1}=8, etc.). The described hysteresis counters (e.g., 526 in FIG. 5) enable the ability to avoid changing/switching the foreground bank hash function (e.g., 508, 511a, 511b, 511c in FIG. 5) at each processing/observation interval (e.g., 516, 518, 520 in FIG. 5) (e.g., frequent changing/switching), which may increase stability for the heuristics described herein for various aspects.

At 1016, the apparatus may execute, as a second foreground process and during a second processing interval of the workload, the first hash function of the set of hash functions based on the adjusted value of the hysteresis counter (i) failing to meet a threshold condition associated with the number of processing intervals or (ii) being a reset value. For example, referring to FIG. 8, at 816b, the graphics processor 804 may be configured to execute (e.g., 616 in FIG. 6; 722 in FIG. 7), as a second foreground process and during a second processing interval (e.g., 516, 518, 520 in FIG. 5) of the workload (e.g., 502 in FIG. 5), (1) the first hash function (e.g., 508, 511a, 511b, 511c in FIG. 5) of the set of hash functions (e.g., 510 in FIG. 5) based on the adjusted (e.g., 712, 716 in FIG. 7) value of the hysteresis counter (e.g., 526 in FIG. 5) (i) failing to meet a threshold condition associated with the number of processing intervals (e.g., 516, 518, 520 in FIG. 5) or (ii) being a reset value or (2) the second hash function (e.g., 508, 511a, 511b, 511c in FIG. 5) of the set of hash functions (e.g., 510 in FIG. 5) based on the adjusted (e.g., 712, 716 in FIG. 7) value of the hysteresis counter (e.g., 526 in FIG. 5) meeting a threshold condition associated with the number of processing intervals (e.g., 516, 518, 520 in FIG. 5). In aspects, the graphics processor 804 may be configured to execute (at 816b) (e.g., 702, 722 in FIG. 7) based on a hysteresis counter (e.g., 526 in FIG. 5) being implemented.

At 1018, the apparatus may re-hash, prior to the execution of the second hash function as the second foreground process, data stored in the memory bank or the memory based on the second hash function, and execute, as a second foreground process and during a second processing interval of the workload for the memory bank, the second hash function of the set of hash functions based on the adjusted value of the hysteresis counter meeting a threshold condition associated with the number of processing intervals. For example, referring to FIG. 8, at 816b, the graphics processor 804 may be configured to execute (e.g., 616 in FIG. 6; 722 in FIG. 7), as a second foreground process and during a second processing interval (e.g., 516, 518, 520 in FIG. 5) of the workload (e.g., 502 in FIG. 5), (1) the first hash function (e.g., 508, 511a, 511b, 511c in FIG. 5) of the set of hash functions (e.g., 510 in FIG. 5) based on the adjusted (e.g., 712, 716 in FIG. 7) value of the hysteresis counter (e.g., 526 in FIG. 5) (i) failing to meet a threshold condition associated with the number of processing intervals (e.g., 516, 518, 520 in FIG. 5) or (ii) being a reset value or (2) the second hash function (e.g., 508, 511a, 511b, 511c in FIG. 5) of the set of hash functions (e.g., 510 in FIG. 5) based on the adjusted (e.g., 712, 716 in FIG. 7) value of the hysteresis counter (e.g., 526 in FIG. 5) meeting a threshold condition associated with the number of processing intervals (e.g., and subsequent to re-hashing (e.g., 614 in FIG. 6; 720 in FIG. 7) the memory (e.g., 512 in FIG. 5)/memory bank(s) (e.g., 514 in FIG. 5) with the second hash function (e.g., 508, 511a, 511b, 511c in FIG. 5)). In aspects, the graphics processor 804 may be configured to execute (at 816b) (e.g., 702, 722 in FIG. 7) based on a hysteresis counter (e.g., 526 in FIG. 5) being implemented.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for determining a first hash function of a set of hash functions associated with a memory bank of a memory for a first processing interval of a workload. The apparatus may include means for executing, as a first foreground process and during the first processing interval of the workload for the memory bank, the first hash function of the set of hash functions. The apparatus may further include means for executing, as a set of background processes and during the first processing interval of the workload, a second hash function of the set of hash functions for the memory bank of the memory. The apparatus may further include means for determining, during the first processing interval of the workload and based on the execution of the first hash function and the execution of the second hash function, a first number of access conflicts associated with the first hash function and with the memory bank and a second number of access conflicts associated with the second hash function and the memory bank. The apparatus may further include means for executing, as a second foreground process and during a second processing interval of the workload for the memory bank, the first hash function of the set of hash functions based on a comparison of the first number of access conflicts to the second number of access conflicts. The apparatus may further include means for determining, subsequent to the first processing interval of the workload and for the comparison, that the first number of access conflicts is less than or equal to the second number of access conflicts. The apparatus may further include means for executing, as a second foreground process and during a second processing interval of the workload for the memory bank, the second hash function of the set of hash functions based on a comparison of the first number of access conflicts to the second number of access conflicts. The apparatus may further include means for determining, subsequent to the first processing interval of the workload and for the comparison, that the second number of access conflicts is less than or equal to the first number of access conflicts. The apparatus may further include means for hashing, prior to the execution of the second hash function as the second foreground process, data stored in the memory bank or the memory based on the second hash function. The apparatus may further include means for executing, as a second foreground process and during a second processing interval of the workload for the memory bank, the first hash function of the set of hash functions based on the adjusted value of the hysteresis counter (i) failing to meet a threshold condition associated with the number of processing intervals or (ii) being a reset value. The apparatus may further include means for executing, as a second foreground process and during a second processing interval of the workload for the memory bank, the second hash function of the set of hash functions based on the adjusted value of the hysteresis counter meeting a threshold condition associated with the number of processing intervals.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, comprising: determining a first hash function of a set of hash functions associated with a memory bank of a memory for a first processing interval of a workload; and executing, as a first foreground process and during the first processing interval of the workload, the first hash function of the set of hash functions.
Aspect 2 is the method of aspect 1, wherein determining the first hash function includes determining, prior to an execution of the first hash function, the first hash function based on a hash indication associated with a driver of the workload.
Aspect 3 is the method of any of aspects 1 and 2, further comprising: executing, as a set of background processes and during the first processing interval of the workload, a second hash function of the set of hash functions for the memory bank of the memory.
Aspect 4 is the method of aspect 3, further comprising: determining, during the first processing interval of the workload and based on the execution of the first hash function and the execution of the second hash function, a first number of access conflicts associated with the first hash function and with the memory bank and a second number of access conflicts associated with the second hash function and the memory bank.
Aspect 5 is the method of aspect 4, further comprising: executing, as a second foreground process and during a second processing interval of the workload, the first hash function of the set of hash functions based on a comparison of the first number of access conflicts to the second number of access conflicts.
Aspect 6 is the method of aspect 5, further comprising: determining, subsequent to the first processing interval of the workload and for the comparison, that the first number of access conflicts is less than or equal to the second number of access conflicts.
Aspect 7 is the method of aspect 4, further comprising: executing, as a second foreground process and during a second processing interval of the workload, the second hash function of the set of hash functions based on a comparison of the first number of access conflicts to the second number of access conflicts.
Aspect 8 is the method of aspect 7, further comprising: determining, subsequent to the first processing interval of the workload and for the comparison, that the second number of access conflicts is less than or equal to the first number of access conflicts.
Aspect 9 is the method of aspect 7, further comprising: re-hashing, prior to the execution of the second hash function as the second foreground process, data stored in the memory bank or the memory based on the second hash function.
Aspect 10 is the method of aspect 4, wherein the first processing interval further comprises a set of additional first processing intervals of the workload, wherein the first processing interval and at least one of the set of additional first processing intervals is separate from each other, wherein a value of a hysteresis counter corresponds to endings of a number of processing intervals comprising the first processing interval and the set of additional first processing intervals.
Aspect 11 is the method of aspect 10, wherein determining the first number of access conflicts and the second number of access conflicts includes: determining a first additional number of access conflicts and a second additional number of access conflicts for each additional first processing interval of the set of additional first processing intervals respectively; and adjusting the value of the hysteresis counter based on first comparisons of the first number of access conflicts to the second number of access conflicts and additional comparisons of the first additional number of access conflicts and the second additional number of access conflicts for each additional first processing interval of the set of additional first processing intervals.
Aspect 12 is the method of aspect 11, further comprising: executing, as a second foreground process and during a second processing interval of the workload, the first hash function of the set of hash functions based on the adjusted value of the hysteresis counter (i) failing to meet a threshold condition associated with the number of processing intervals or (ii) being a reset value.
Aspect 13 is the method of aspect 11, further comprising: executing, as a second foreground process and during a second processing interval of the workload, the second hash function of the set of hash functions based on the adjusted value of the hysteresis counter meeting a threshold condition associated with the number of processing intervals.
Aspect 14 is the method of aspect 11, wherein the hysteresis counter is a K-bit hysteresis counter, wherein a hysteresis counter value of 2^{K-1} for the K-bit hysteresis counter meets a threshold condition associated with the number of processing intervals.
Aspect 15 is the method of aspect 4, wherein a length of the first processing interval is based on a resource utilization metric associated with a hashing of the memory or the memory bank subsequent to an initiation of the first processing interval.
Aspect 16 is the method of aspect 4, wherein a length of the first processing interval is based on a number of memory bank accesses to the memory bank subsequent to an initiation of the first processing interval of the workload.
Aspect 17 is the method of any of aspects 1 to 16, wherein the memory is a local memory, a cache, or a scratch pad memory that is coupled to a graphics processing unit (GPU).
Aspect 18 is the method of any of aspects 1 to 17, wherein the method is performed by a wireless communication device.
Aspect 19 is an apparatus for graphics processing comprising a processor coupled to a memory and, based on information stored in the memory, the processor is configured to implement a method as in any of aspects 1-18.
Aspect 20 may be combined with aspect 19 and comprises that the apparatus is a wireless communication device.
Aspect 21 is an apparatus for graphics processing comprising means for implementing a method as in any of aspects 1-18.
Aspect 22 is a computer-readable medium (e.g., a non-transitory computer readable-medium) storing computer executable code, the computer executable code, when executed by a processor, causes the processor to implement a method as in any of aspects 1-18.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
determine a first hash function of a set of hash functions associated with a memory bank of the memory for a first processing interval of a workload; and
execute, as a first foreground process and during the first processing interval of the workload, the first hash function of the set of hash functions.

2. The apparatus of claim 1, wherein to determine the first hash function, the processor is configured to determine, prior to an execution of the first hash function, the first hash function based on a hash indication associated with a driver of the workload.

3. The apparatus of claim 1, wherein the processor is further configured to:
execute, as a set of background processes and during the first processing interval of the workload, a second hash function of the set of hash functions for the memory bank of the memory.

4. The apparatus of claim 3, wherein the processor is further configured to:
determine, during the first processing interval of the workload and based on the execution of the first hash function and the execution of the second hash function, a first number of access conflicts associated with the first hash function and with the memory bank and a second number of access conflicts associated with the second hash function and the memory bank.

5. The apparatus of claim 4, wherein the processor is further configured to:
execute, as a second foreground process and during a second processing interval of the workload, the first hash function of the set of hash functions based on a comparison of the first number of access conflicts to the second number of access conflicts.

6. The apparatus of claim 5, wherein the processor is further configured to:
determine, subsequent to the first processing interval of the workload and for the comparison, that the first number of access conflicts is less than or equal to the second number of access conflicts.

7. The apparatus of claim 4, wherein the processor is further configured to:
execute, as a second foreground process and during a second processing interval of the workload, the second hash function of the set of hash functions based on a comparison of the first number of access conflicts to the second number of access conflicts.

8. The apparatus of claim 7, wherein the processor is further configured to:
determine, subsequent to the first processing interval of the workload and for the comparison, that the second number of access conflicts is less than or equal to the first number of access conflicts.

9. The apparatus of claim 7, wherein the processor is further configured to:
re-hash, prior to the execution of the second hash function as the second foreground process, data stored in the memory bank or the memory based on the second hash function.

10. The apparatus of claim 4, wherein the first processing interval further comprises a set of additional first processing intervals of the workload, wherein the first processing interval and at least one of the set of additional first processing intervals is separate from each other, wherein a value of a hysteresis counter corresponds to endings of a number of processing intervals comprising the first processing interval and the set of additional first processing intervals.

11. The apparatus of claim 10, wherein to determine the first number of access conflicts and the second number of access conflicts, the processor is configured to:
determine a first additional number of access conflicts and a second additional number of access conflicts for each additional first processing interval of the set of additional first processing intervals respectively; and
adjust the value of the hysteresis counter based on first comparisons of the first number of access conflicts to the second number of access conflicts and additional comparisons of the first additional number of access conflicts and the second additional number of access conflicts for each additional first processing interval of the set of additional first processing intervals.

12. The apparatus of claim 11, wherein the processor is further configured to:
execute, as a second foreground process and during a second processing interval of the workload, the first hash function of the set of hash functions based on the adjusted value of the hysteresis counter (i) failing to meet a threshold condition associated with the number of processing intervals or (ii) being a reset value.

13. The apparatus of claim 11, wherein the processor is further configured to:
execute, as a second foreground process and during a second processing interval of the workload, the second hash function of the set of hash functions based on the adjusted value of the hysteresis counter meeting a threshold condition associated with the number of processing intervals.

14. The apparatus of claim 11, wherein the hysteresis counter is a K-bit hysteresis counter, wherein a hysteresis counter value of 2^{K-1} for the K-bit hysteresis counter meets a threshold condition associated with the number of processing intervals.

15. The apparatus of claim 4, wherein a length of the first processing interval is based on a resource utilization metric associated with a hashing of the memory or the memory bank subsequent to an initiation of the first processing interval.

16. The apparatus of claim 4, wherein a length of the first processing interval is based on a number of memory bank accesses to the memory bank subsequent to an initiation of the first processing interval of the workload.

17. The apparatus of claim 1, wherein the memory is a local memory, a cache, or a scratch pad memory that is coupled to a graphics processing unit (GPU).

18. The apparatus of claim 1, wherein the apparatus is a wireless communication device.

19. A method of graphics processing, comprising:
determining a first hash function of a set of hash functions associated with a memory bank of a memory for a first processing interval of a workload; and
executing, as a first foreground process and during the first processing interval of the workload, the first hash function of the set of hash functions.

20. A computer-readable medium storing computer executable code, the computer executable code, when executed by a processor, causes the processor to:
determine a first hash function of a set of hash functions associated with a memory bank of a memory for a first processing interval of a workload; and
execute, as a first foreground process and during the first processing interval of the workload, the first hash function of the set of hash functions.
